(19) United States
(12) Patent Application Publication
(10) Pub. No.: US 2025/0037907 A1
(43) Pub. Date: Jan. 30, 2025

(54) HARNESS ASSEMBLY SYSTEM AND METHOD OF ASSEMBLING A HARNESS

(71) Applicant: Thor Tech, Inc., Elkhart, IN (US)

(72) Inventors: Steven J. Romanowski, Albion, IN (US); Trent M. Tobolski, South Bend, IN (US); Divyesh H. Patel, Sacramento, CA (US); Carl D. Smith, Niles, MI (US); Steffan A. Werth, Issaquah, WA (US)

(21) Appl. No.: 18/780,980

(22) Filed: Jul. 23, 2024

Related U.S. Application Data
(60) Provisional application No. 63/515,412, filed on Jul. 25, 2023.

(51) Int. Cl. H01B 13/012; B25J 11/00; B60R 16/02

(52) U.S. Cl. CPC H01B 13/01245; B25J 11/005; B60R 16/0207

(57) ABSTRACT

A wire harness assembly system for assembling a wire harness includes a table top supported above a floor along a Y axis, with the table top having a support surface having a perimeter and extending in an X axis and a Z axis. A plurality of guides is mounted relative to the table top in known locations across the support surface wherein each of the guides has a unique known location along the X and Z axes, and wherein the plurality of guides defines a plurality of wire paths for harness wires to form a variety of harnesses. The system further includes a robot supported adjacent the table top, with the robot having a robotic arm configured to engage a harness wire and to lay the harness wire in a selected wire path of the plurality of wire paths.

### CROSS REFERENCE TO RELATED APPLICATION

This application claims the benefit of U.S. Prov. App. Ser. No. 63/515,412, filed on Jul. 25, 2023, which is incorporated by reference herein in its entirety.

### TECHNICAL FIELD AND BACKGROUND

The wire harness is a key part of any vehicle. Traditionally, the wire harness assembly and manufacturing process is manual. In the recreational vehicle industry, wire harness assembly is particularly labor intensive given the length and complexity of the harness.

The current harness manufacturing process uses linear tables with static pins to route harness wires. Most scenarios require tables that are configured with pin arrangements unique to specific models, creating a large inventory of tables for different models and model change overs.

In today's scenario, after wire is cut, it is coiled and staged manually for the next process. During this process, an operator goes through lot of physical strain, coiling wire of more than average of 6,000 feet per vehicle.

### SUMMARY

Accordingly, a wire harness assembly system is provided that is configured to enable the use of one or more robots to lay wire on a wire harness layup table that can provide multiple wire paths in a more compact footprint and, further, has a guide pin arrangement that can avail itself of the full reach of a robot.

A wire harness assembly system for assembling a wire harness includes a table top and a plurality of guides mounted relative to the table top. The table top is supported above a floor along a Y axis and has a support surface with a perimeter. The table top extends along an X axis and a Z axis. The guides are mounted relative to the table top in known locations across the support surface wherein each guide has a unique known location along the X and Z axes. The guides define a plurality of wire paths for harness wires to form a variety of harnesses. The wire harness assembly system also includes a robot supported adjacent the table top. The robot has a robotic arm configured to engage a harness wire and to lay the harness wire in a selected wire path of the plurality of wire paths.

In one aspect, the plurality of guides are located in an annular arrangement on the table top. For example, the guides may be located in an annular arrangement along concentric axes and radial axes on the table top.

In another aspect, the table top comprises an annular table top having a center axis, with the robot located at the center axis.

In yet other aspects, the table top further includes a control system. The control system has access to information about a wire harness that is to be assembled on the table top and is configured to select a wire path from the plurality of wire paths based on the information about the wire harness and to have the robot lay a wire in the selected wire path.

For example, the control system may be a robot-based control system at the robot.

In yet a further aspect, the information about the wire harness may be resident in the robot-based control system.

According to another aspect, the table top further includes at least one tray located adjacent the support surface of the table top. The tray is configured to support thereon a plurality of connectors located at spaced locations around a portion of the perimeter of the support surface outside the footprint of the guides.

In yet another aspect, the robot has a work cell, and the wire harness assembly further includes an accumulator for holding a plurality of bobbins in the work cell of the robot.

According to another embodiment, the wire harness assembly system for assembling a wire harness includes a table top and a plurality of guides mounted relative to the table top, which form guide paths for wires. The wire harness assembly system also includes a robot supported adjacent the table top. The wire harness assembly system further includes an accumulator for holding a plurality of bobbins in the work cell of the robot, with at least one of the bobbins having a harness wire wound thereon. The robot has a robotic arm that is configured to engage the at least one bobbin from the accumulator and to lay the wire of the bobbin along a selected wire path of the plurality of wire paths.

In one aspect, the accumulator includes a rotatable support with a plurality of bobbin holders for holding the plurality of bobbins.

In another aspect, the robot comprises a first robot, and the wire harness assembly system further includes a second robot. The second robot is configured to place filled bobbins on the accumulator

In a further aspect, the first robot is configured to place an empty bobbin on the accumulator after laying the wire of the empty bobbin on the table top. Further, the second robot is configured to pick one or more empty bobbins from the accumulator.

In yet another aspect, the table top comprises an annular table top having a center axis, with the robot located at the center axis.

According to yet another aspect, the wire harness assembly system further includes a control system, which has access to information about a wire harness that is to be assembled on the table top and configured to select a wire path from the plurality of wire paths based on the information about the wire harness and to have the robot lay a wire in the selected wire path.

For example, the control system may be a master control system, with the robot having a robot-based control system, and with the master control system in communication with the robot-based control system.

In yet other aspects, the wire harness assembly system further includes at least one tray located adjacent the support surface of the table top, which his provided to support excess wire.

In a further aspect, the tray supports a plurality of connectors located at spaced locations around a portion of the perimeter of the support surface for access by the robot.

In yet another embodiment, a wire harness assembly system for assembling a wire harness includes a table top supported relative to a floor, the table top having a support surface having a perimeter and extending in an X axis and a Y axis, and a plurality of guides mounted relative to the table top in known locations across the support surface of the table top wherein each guide has a unique known location along the X and Y axes. The guides define a plurality of wire paths for harness wires to form a variety of harnesses. In addition, the guides are retractable wherein said table top is free of any projections when the guides are retracted.

In addition, the wire harness assembly system includes a robot supported adjacent the table top, with the robot having a robotic arm configured to engage a harness wire and to lay the harness wire in a selected wire path.

In one aspect, the guides are retractable as a group or in groups.

In other aspects, the plurality of guides are located in an annular arrangement on the table top. For example, the guides may be located along concentric axes and radial axes on the table top.

In yet another embodiment, a wire harness assembly system for assembling a wire harness in a work space includes a table with a table top and a movable base supported for movement between two or more locations in the work space. The table top has a support surface extending in an X axis and a Z axis. A plurality of guides are mounted relative to the table top in known locations across the support surface in an arrangement wherein each guide has a unique known location along said X and Z axes, which define a plurality of wire paths for the wires. The wire harness assembly system also includes a wire bobbin holding wire of a known fixed length, with the wire bobbin supported adjacent the movable base.

The wire harness assembly system also includes a robotic arm supported adjacent the table top when the movable base is located in a first location of the two or more locations, with the robotic arm configured to retrieve the wire bobbin and engage the wire and to lay the wire in a selected wire path of the plurality of wire paths.

In one aspect, the annular arrangement includes guides arranged along annular concentric axes and along radial axes on the table top.

According to yet another embodiment, a wire harness layup table includes a table top supported relative to a floor along a Y axis, with the table top including a support surface having a perimeter and extending in an X axis and a Z axis. A plurality of guides are mounted relative to the table top in known locations across the support surface wherein each guide has a unique known location along the X and Z axes. The plurality of guides are located in an annular arrangement on the table top along concentric axes and radial axes defining a plurality of wire paths for harness wires to form a variety of harnesses.

In one aspect, the table top comprises an annular table top.

In other aspects, the guides comprise guide pins. Optionally, the guides comprise retractable guide pins.

In a further aspect, the guide pins have distal ends, with the distal ends flush or beneath the support surface when retracted.

According to yet another embodiment, a wire harness bobbin includes a central hub, upper and lower flanges mounted about the central hub for holding a wire on the wire harness bobbin when the wire is wrapped around the central hub, and a coupler formed or mounted relative to the upper flange for engagement by a robotic arm.

In one aspect, the coupler comprises a pin.

In a further aspect, the wire harness bobbin further includes a second coupler for coupling the wire harness bobbin to a support, such as a rotatable plate.

Optionally, the wire harness bobbin further includes one or more wire holders for holding the end of a wire wrapped around the central hub.

In a further aspect, the wire harness bobbin further includes a second wire holder for holding another end of the wire wrapped around the central hub.

In yet a further aspect, the wire holders are mounted to the upper and lower flanges, respectively. For example, the upper and lower flanges each have an inwardly facing side, with the wire holders mounted to the inwardly facing sides of the upper and lower flanges, respectively.

These and other objects, advantages, purposes and features of this invention will become apparent upon review of the following specification in conjunction with the drawings.

### DESCRIPTION OF THE DRAWINGS

FIG. 1A is a perspective view of a wire harness assembly system;

FIG. 1B is a schematic of the wire harness assembly system of FIG. 1A and its various components;

FIG. 2 is a perspective view similar to FIG. 1A illustrating the tables of the system moving between different stations of the wire harness assembly system;

FIG. 3 is a perspective view similar to FIG. 2 illustrating the tables of the system moving between different stations of the wire harness assembly system;

FIG. 3A is an enlarged perspective view of one of the table with the table base removed and illustrating an embodiment of the table top and guide arrangement;

FIG. 3B is an enlarged fragmentary view of the tray located adjacent the table top illustrating a connector holder and connector;

FIG. 3C is an exploded perspective view of the tray, the connector holder, and the connector of FIG. 3B;

FIG. 4A is an enlarged perspective view of a table configuration of the wire harness assembly system illustrating a first robot in a wire placement position adjacent the table and a second robot in a wire bobbin preparation position in a wire bobbin preparation area;

FIG. 4B is an enlarged perspective view similar to FIG. 4A illustrating the second robot placing a first bobbin in position for receiving wire from a wire cut-to-length apparatus;

FIG. 4C is an enlarged perspective view similar to FIG. 4B illustrating the second robot placing the first bobbin with wire coiled about the first bobbin in position adjacent a wire testing apparatus;

FIG. 4D is an enlarged perspective view similar to FIG. 4C illustrating the second robot placing the first bobbin in position for positioning the wire of the first bobbin by the first robot on the table;

FIG. 4E is an enlarged perspective view similar to FIG. 4D illustrating the first robot gripping the first bobbin and the second robot in the wire processing area for preparing other bobbins for use by the first robot;

FIG. 4F is an enlarged perspective view similar to FIG. 4E illustrating the first robot laying the wire from the first bobbin on the table on a path between the guides while the second robot is positioning a second bobbin adjacent a split and termination machine to prepare the second bobbin for use by the first robot;

FIG. 4G an enlarged perspective view similar to FIG. 4F illustrating the first robot gripping the second bobbin while the second robot is preparing a third bobbin;

FIG. 4H is an enlarged plan view illustrating the first robot laying the wire of the second bobbin on the table on a path between the guides;

FIG. 4I is an enlarged perspective view illustrating the first robot gripping a third bobbin while the second robot is preparing a fourth bobbin for use by the first robot;

FIG. 4J is an enlarged plan view illustrating the first robot gripping laying the wire of the third bobbin on the table on a path between the guides;

FIG. 4K is an enlarged plan view illustrating the first robot gripping laying the wire of the third bobbin on the table on a path between the guides;

FIG. 5A is an enlarged perspective view of a bobbin with a wire wound around the bobbin;

FIG. 5B is a perspective view of a bobbin accumulator;

FIG. 6 is a plan view of an alternate embodiment of the wire harness assembly system with two stations arranged and two adjacent wire harness assembly loops or circuits; and

FIG. 7 is a plan view of a third embodiment of the wire harness assembly system with a compact arrangement of stations arranged around a single table.

### DETAILED DESCRIPTION

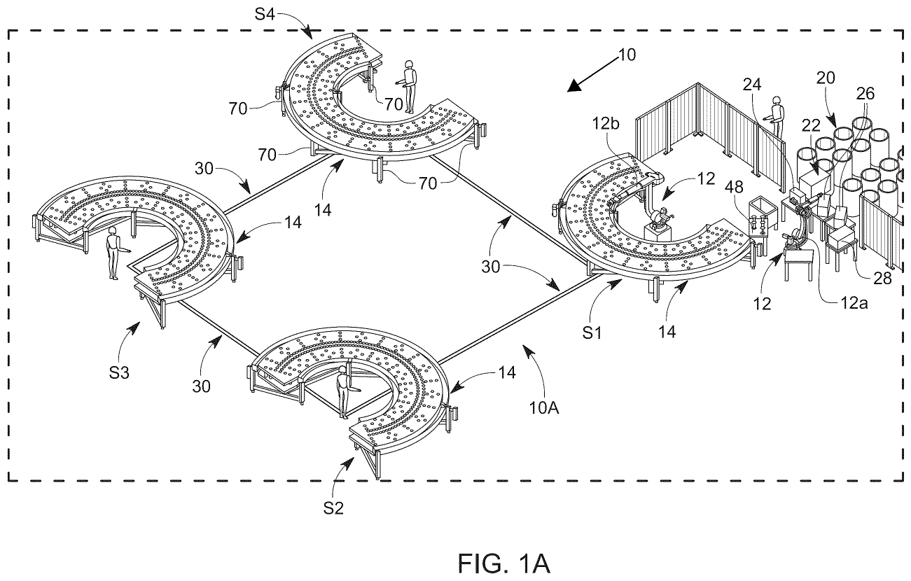

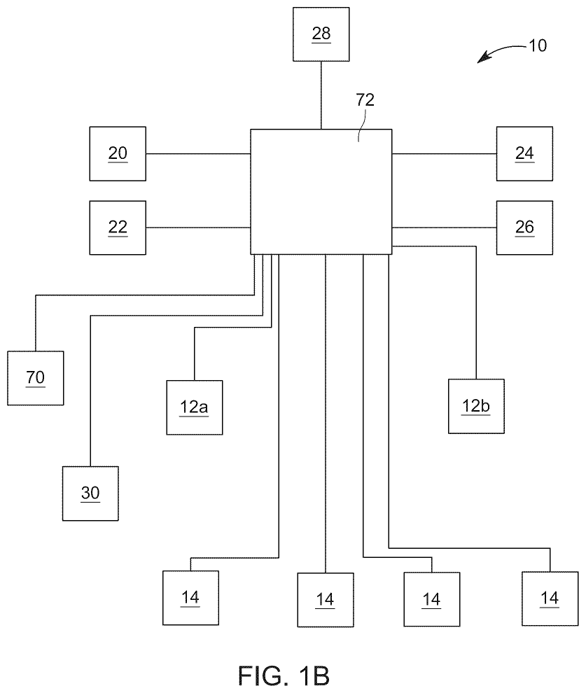

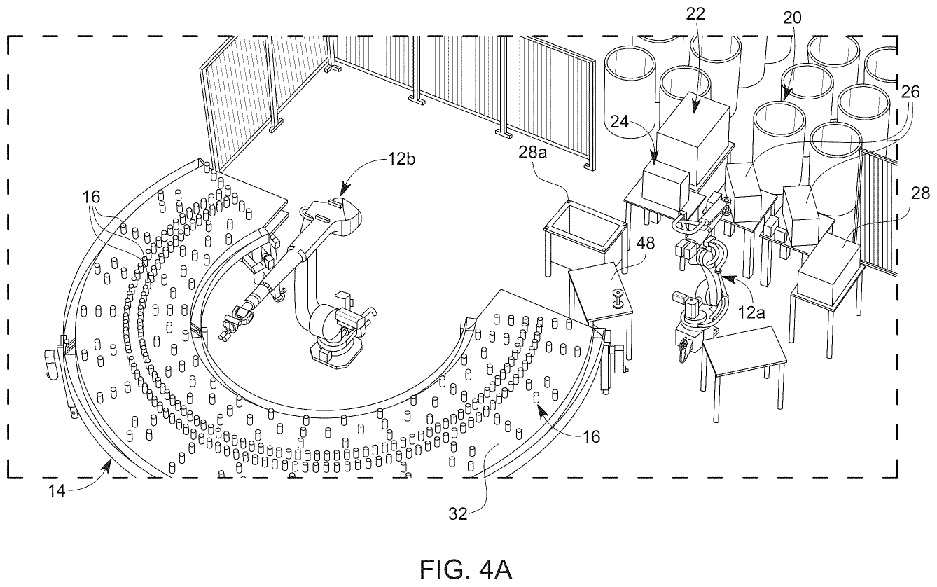

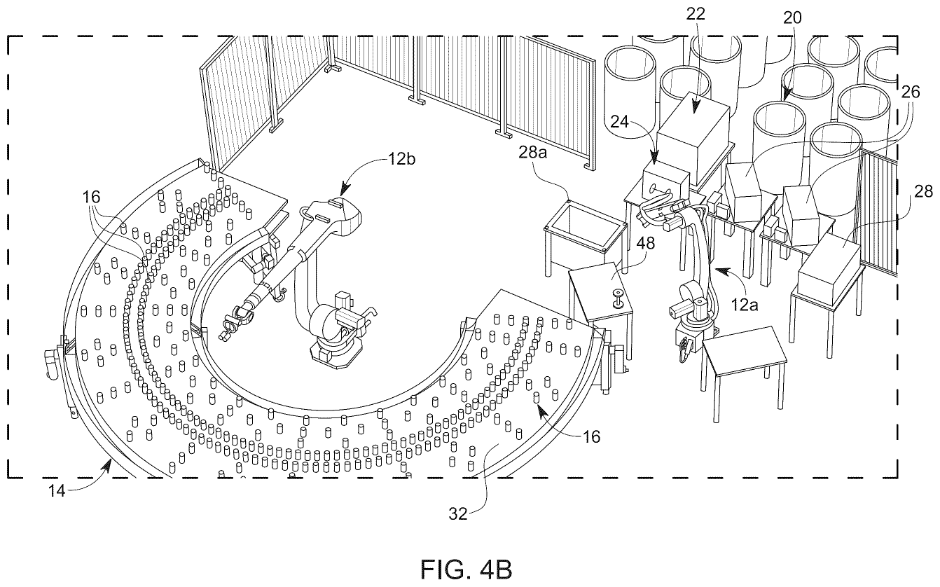

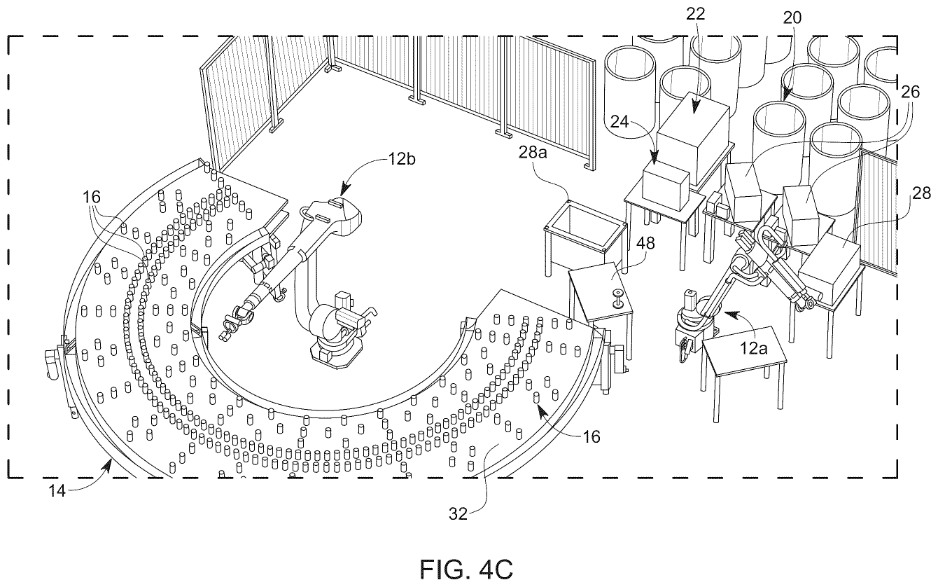

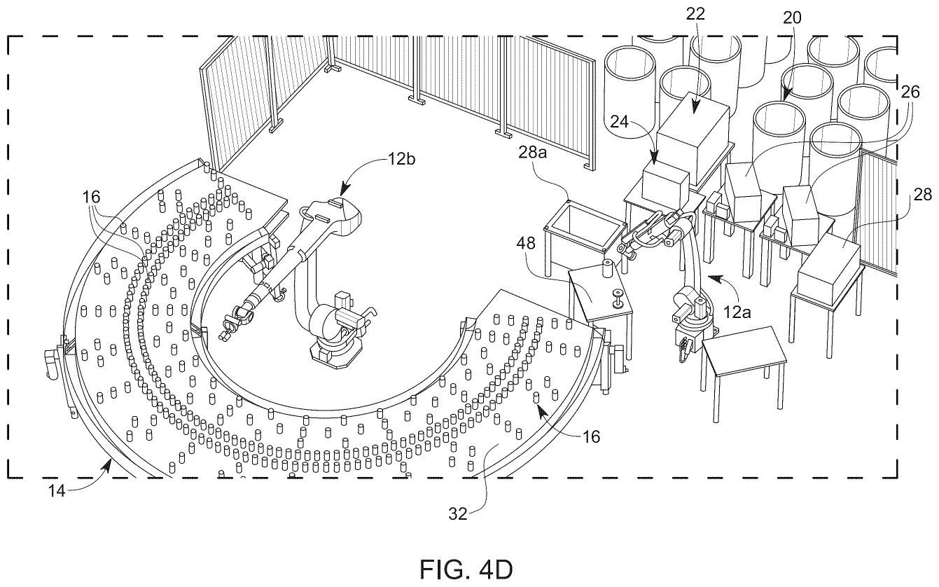

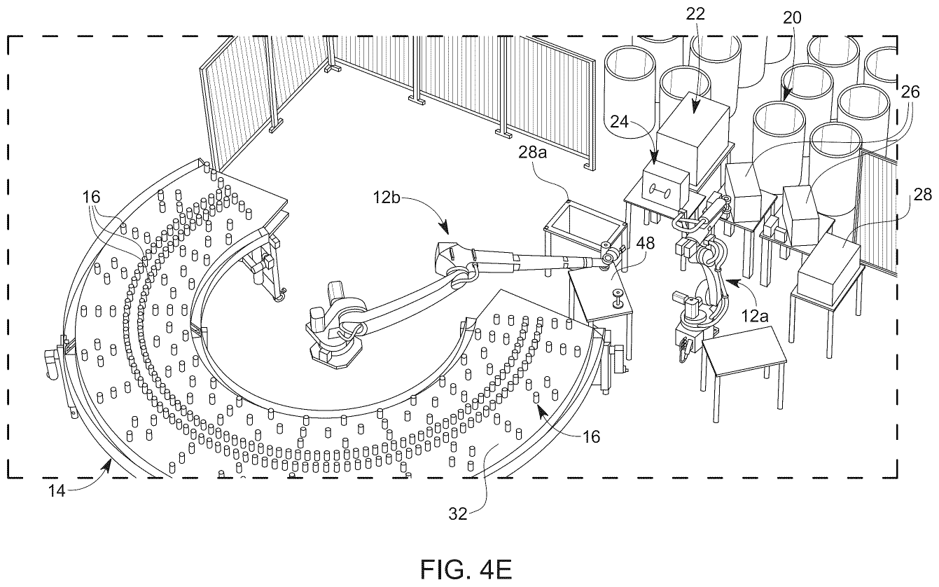

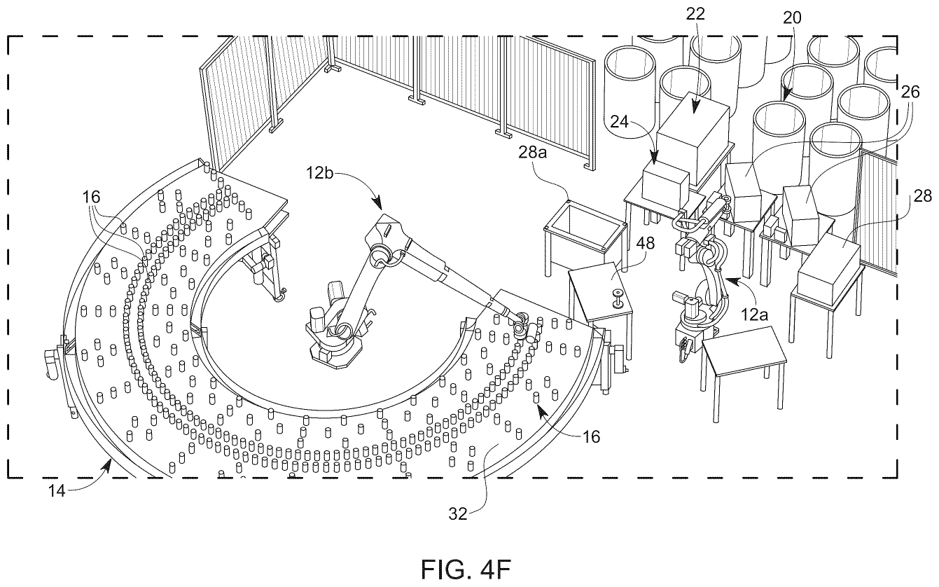

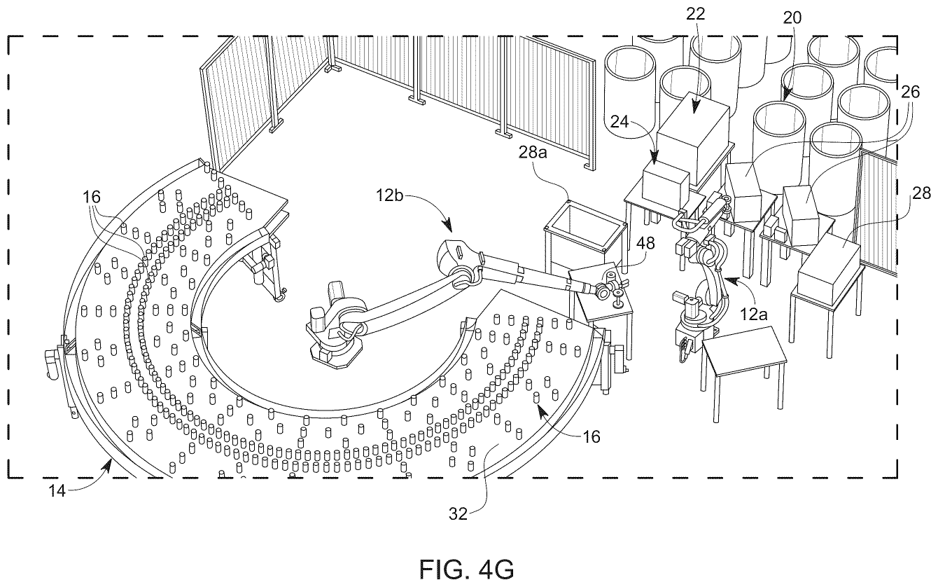

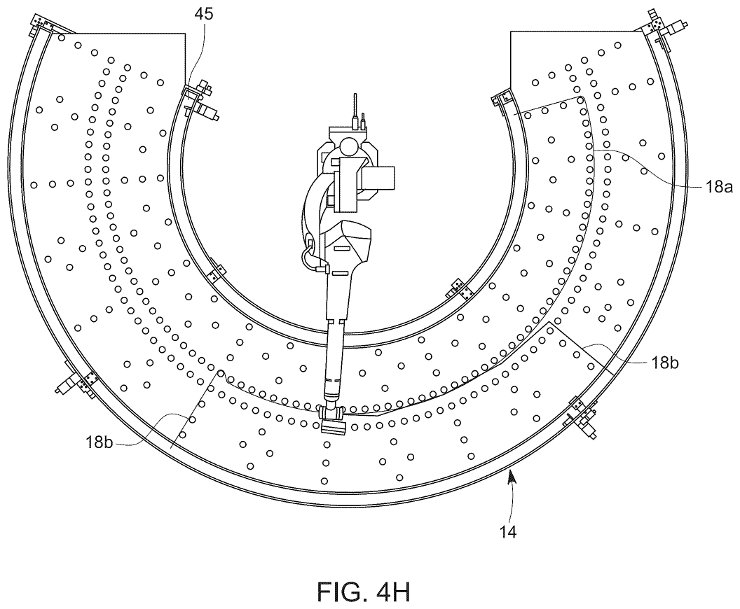

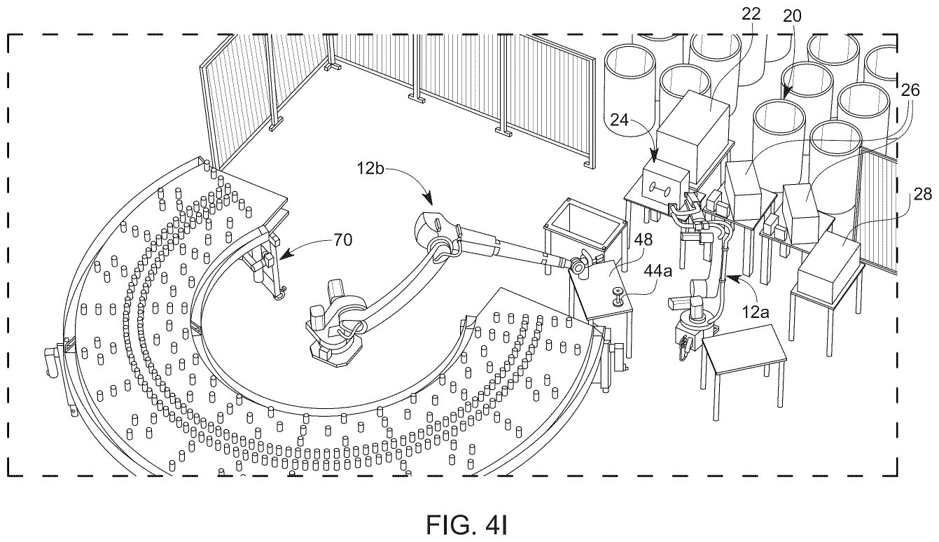

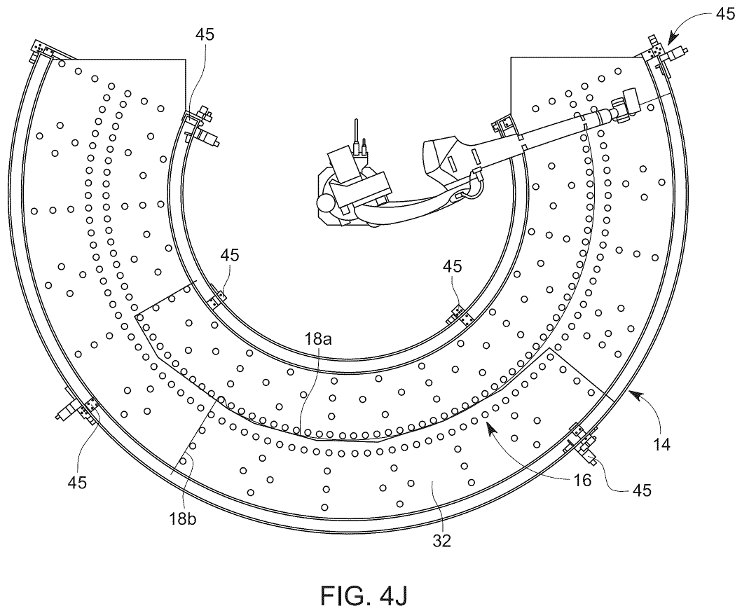

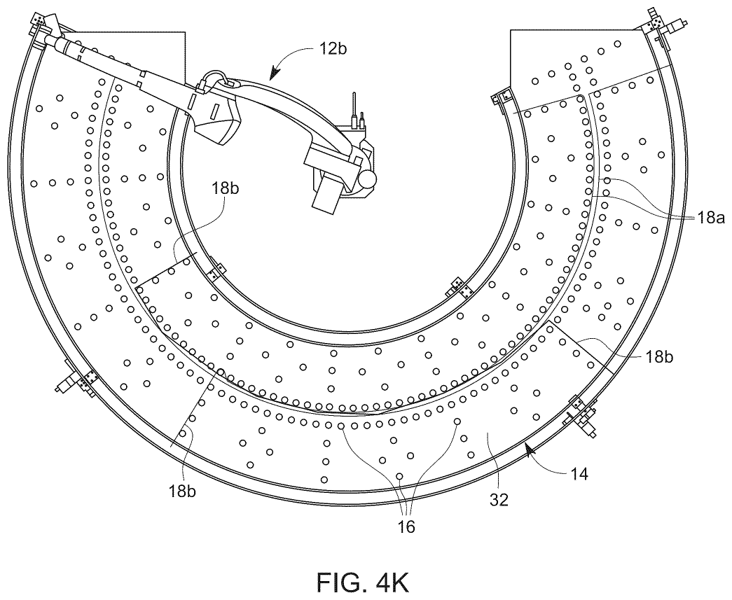

Referring to FIG. 1A, the numeral 10 generally designates a wire harness assembly system that is configured to enable the use of one or more robots 12 to lay wire on one or more wire harness layup tables 14, with each wire harness layup table 14 configured to provide multiple wire paths in a compact footprint. As will be more fully described below, each wire harness layup table 14 is configured with an annular array of guides 16 that are arranged in a horizontal plane (along X and Z axes) to form a plurality of annular and radial guide paths 18a, 18b (best illustrated in FIG. 4H) that allow a robot to use its full reach (both extended and rotated) to lay out wire on the table.

In addition, the wire harness assembly system 10 also includes a wire feed 20, such as drums filled with wire, a wire cutting apparatus 22, a wire winding apparatus 24, and a split and termination machine 26. The wire harness assembly system 10 may also include a wire testing apparatus 28. Wire cutting apparatus 22, wire winding apparatus 24, split and termination machine 26, and optional wire testing apparatus 28 may all comprise conventional equipment, such as cut and strip machines, wire handling machines, crimpers or crimping machines, and testing systems, including low-voltage testing systems, available from KOMAX or cutting machines, crimping machines, or crimp applicators available from SCHLEUNIGER. Further, as will be more fully described below the wire harness assembly system 10 may include a bobbin accumulator that can help manage the handling one or more empty bobbins and a plurality of full bobbins, for example after the bobbins are wound with a wire (and the wire terminated and tested) and ready for layup on the wire harness layup table 14.

Referring to FIG. 1A, wire harness layup table 14 is a movable table and coupled to a conveyor 30, such as a motorized track (or pair of tracks), so that wire harness layup table 14 can be indexed between multiple stations, for example, between work stations S1, S2, S3, S4, where either robots and/or workers can work on the wire harness layup table 14 to complete one or more wire harness assembly processes. Alternately, the tables may be indexed by an automated guidance (AGV) system with each table having its own drive or drivers, such as motorized casters.

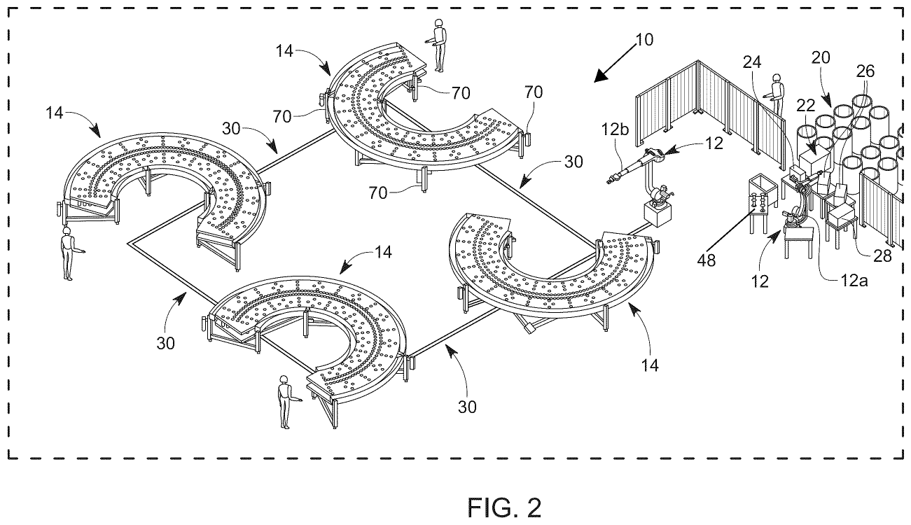

As best seen in FIGS. 1-3, the base of wire harness layup table 14 has a plurality of legs 70, which support the table above a floor surface (along the Y axis) and have bearings to allow the wire harness layup table 14 be indexed between its work stations by the conveyor (or AGV system). For example, one or more of the legs may be coupled to the conveyor 30 to allow the conveyor 30 to move the respective tables and allow the tables to be moved (translated and rotated) between the respective stations shown in FIGS. 1-3.

Movement of the conveyor 30, and hence wire harness layup tables 14, may be controlled by a master control system 72 (FIG. 1B). Master control system 72 may be in communication with robots 12a, 12b, conveyor 30, wire feeder 20, wire cutting apparatus 22, wire winding apparatus 24, split and termination machine 26, and optional wire testing apparatus 28, for controlling the respective apparatuses and machines as well as the movement of the table and providing input into the respective robots. It should be understood that local control or manual control (including a manual override) may be provided for any of the components of wire harness assembly system 10.

Master control system 72 may include one or more microprocessors, microcontrollers, field programmable gate arrays, systems on a chip, volatile or nonvolatile memory, discrete circuitry, and/or other hardware, software, or firmware that is capable of carrying out the functions described herein, as would be known to one of ordinary skill in the art. Further, master control system 72 may include a manufacturing execution system and use human machine interface (HMI) hardware and/or software to allow an operator to interact with the controller of the master control system (or any of the controllers of the components in the system) to allow the operator to input job selection and other input. In this manner, master control system 72 may control the work flow—that is manage the schedule and mode of operation of each work cell. The robots may have access to the wire harness layup table data (e.g., table dimensions, guide pin layout, and/or wire pathways), which can be resident in the robots or may be pulled by the robots from the main control system.

Master control system 72 may also include other electronic components that are programed to carry out the functions described herein, or that support the microcontrollers, microprocessors, and/or other electronics. Such components can be physically configured in any suitable manner, such as by mounting them to one or more circuit boards, or arranging them in other manners, whether combined into a single unit or distributed across multiple units. Such components may be physically distributed in different positions in system 10, or they may reside in a common location in system 10. When physically distributed, the components may communicate using any suitable serial or parallel communication protocol, such as, but not limited to, CAN, LIN, Firewire, I-squared-C, RS-232, RS-485, or the like.

In the illustrated embodiment, work station S1 is the first work station in the work area or assembly process and is configured to accommodate two robots 12a, 12b both having bases mounted and fixed at spaced operating locations where the robots 12a, 12b prepare a wire (robot 12a) and lay the wire (robot 12b) on wire harness layup table 14. Work station S1 also has a defined, known location for wire harness layup table 14 such that that when wire harness layup table 14 is within the footprint of robot 12b's work cell—in other words the area that is within the full reach of the robotic arm of the robot—the robot will know where the table is and more importantly where each guide is located.

Robots 12a, 12b are conventional industrial robots each with an onboard control system (e.g., processor, memory, and controller, which is in communication with master control system 72), and a robotic arm that is configured to move, including to extend and contract and rotate, relative to the base of the robot. Each arm is fitted with a tool (often referred to as an “end of arm tooling”) to grab and hold and manipulate the bobbins, wire, and connectors, as described herein. As noted above, wire harness assembly system 10 also includes master control system 72 that communicates with the robots as well as the various components described herein.

In the illustrated embodiment, wire harness layup table 14 has a central opening 14a that is centered about the base of robot 12b and is sized so that wire harness layup table 14 is totally within the footprint of robot 12b's work cell. Further, as best seen in FIGS. 1, 3A, 4, 4A-4J, wire harness layup table 14 has an annular table top 32 that is supported on a base and allows robot 12b to be located at the center axis of the annular table top 32 so that the robot 12b can use most of, if not all of, the working upper surface 32a of the annular table top 32 to lay the wire on wire harness layup table 14.

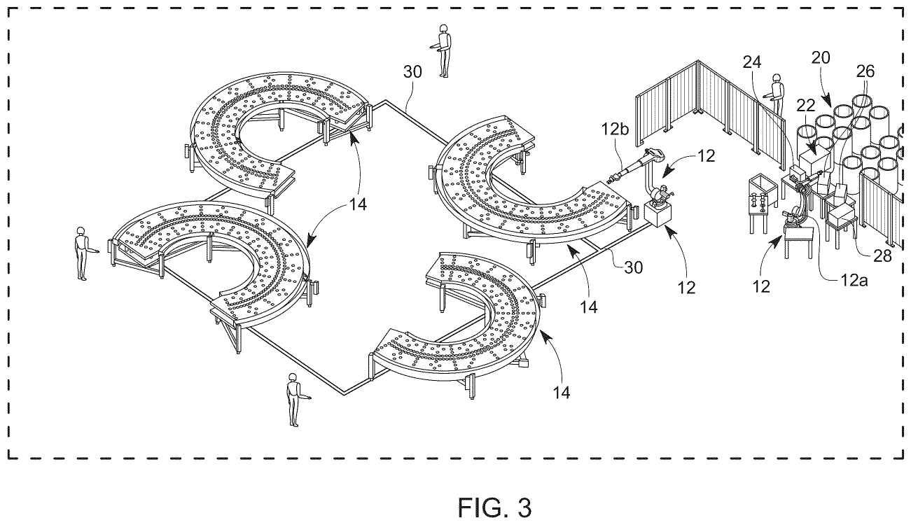

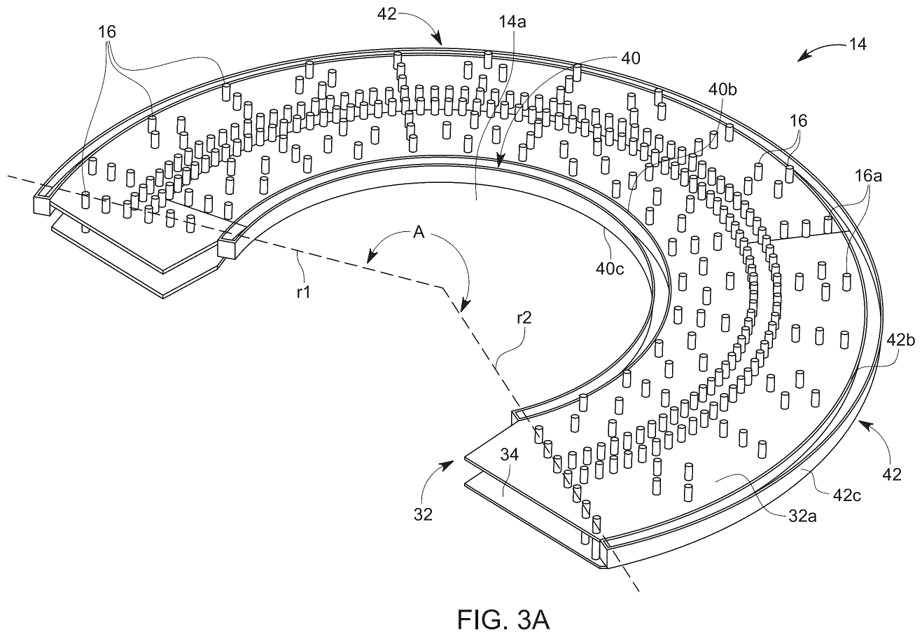

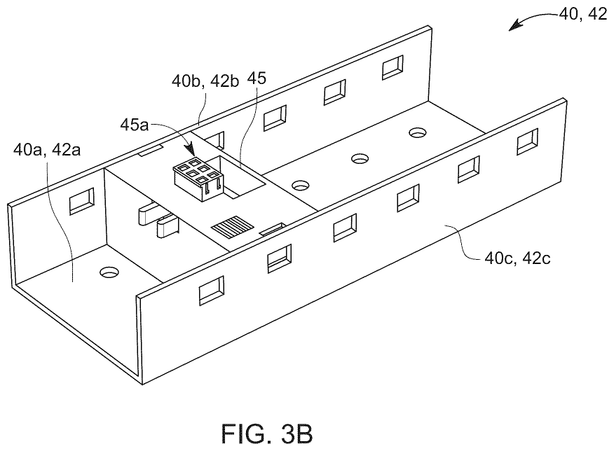

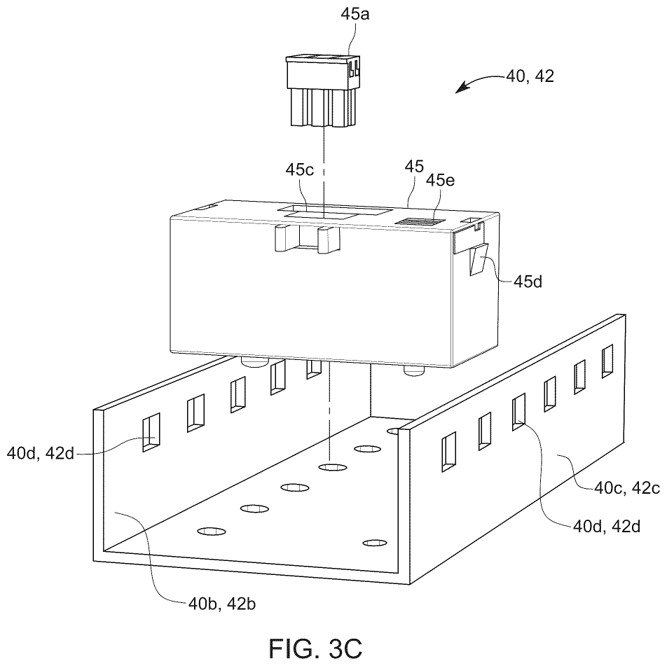

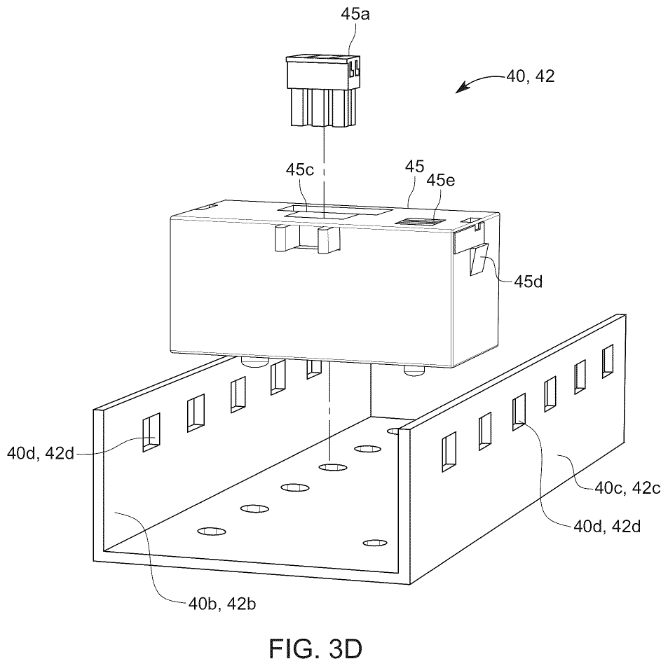

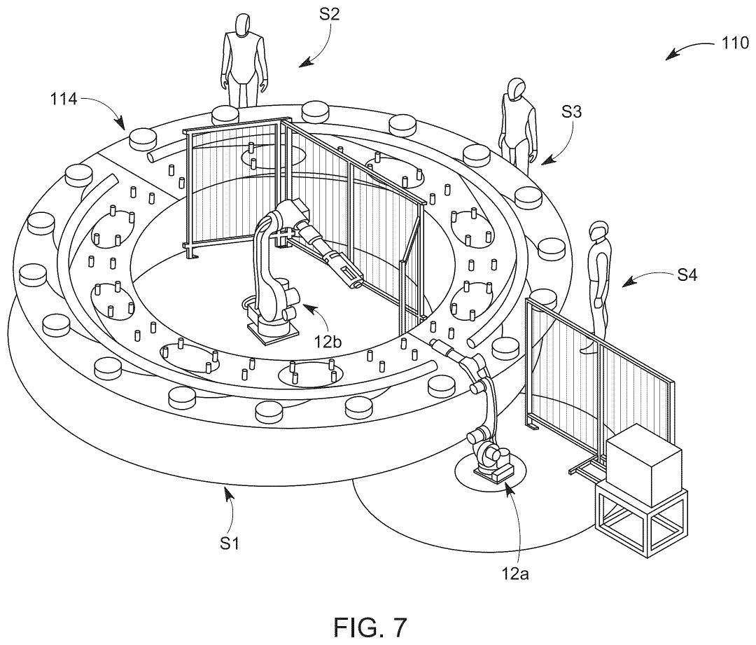

The arc of annular table top 32 may be varied to increase the length and the number of the layup paths for the wires provided by guide pins 16 and/or to reduce the footprint of the wire harness layup table 14. For example, the arc A (FIG. 3A) as measured from the radii r1, r1 that extend through the outer most array of guides 16 may fall in a range of about 180 degrees to about 330 degrees. By placing the lay-up pattern in an arc shape, space can be saved while harness is being built. The annular shaped of the table top 32 also makes moving table easier. It should be understood that the stated arc angle range is exemplary and may be varied. For example, for shorter harnesses, the arc angle may be less than 180 degrees. Further, as will be more fully described in reference to the embodiment illustrated in FIG. 7, the arc angle may be increased to 360 degrees and, hence, form a circular table.

Referring again to FIG. 3A, as noted, wire harness layup table 14 may have annular table top 32. Guides 16, for example in the form of guide pins 16a, are mounted to annular table top 32 at spaced locations around annular table top 32, both on concentric axes and radial axes (e.g. axes r1, r2, . . . rn) to form the plurality of annular and radial guide paths 18a, 18b (FIGS. 4H and 4K)) for robot 12b to lay the wire. It should be understood that a desired wire path for a given harness may have annular and radial components.

Guide pins 16a may be fixed or may be retractable. For example, guide pins 16 may be moved from a stowed position where their distal ends are flush with or below the upper surface 32a of annular table top 32, and an extended, deployed position (as shown in FIG. 3A) where their distal ends are raised above upper surface 32a of annular table top 32. Lowering the guide pins provides easier access to the assembled harness, which can weigh several hundred pounds.

Guide pins 16a may be moved all together or may be individually moved. For example, when moved together, the guide pins 16a may be commonly mounted on a support 34 (FIG. 3A), such as an annular plate beneath annular table top 32, which is raised or lowered relative to annular table top 32 to extend or retract the guide pins 16a through openings provided in annular table top 32. When individually moved, each guide pin 16a may be moved by a dedicated driver, such as using a gear and motor arrangement or a solenoid. Further, the guide pins 16a may be moved in groups and, hence, mounted in groups on a common support, such as a plate, with each support moved by a dedicated driver. When individually moved, the wire paths formed by the guide pins may be customized even further.

Referring again to FIG. 3A, wire harness layup table 14 includes inner and outer trays 40, 42, which are mounted adjacent annular table top 32 to hold a wire when it is initially laid on wire harness layup table 14 as well as excess wire. Trays 40, 42 may also be used locate connector holders 45 that hold one or more connectors 45a, which are to be coupled to the ends of at least some of the wires.

As best seen in FIGS. 3B and 3C, trays 40 and 42 each have an annular base wall or web 40a, 42a and upwardly extending inner and outer annular flanges 40b,c and 42b,c to thereby form channel shaped trays. In this manner, inner flanges 40b, 42b and outer flanges 40c, 42c define the inner and outer boundary of upper surface 32a of annular table top 32.

Inner flanges 40b, 42b may extend downwardly from upper surface 32a of annular table top 32 with their upper edges flush with upper surface 32a of annular table top 32 so that the opposed ends of the wire may just lay over the inner flanges 40b, 42b and extend into the respective trays. Alternately, the upper edges of inner flanges 40b, 42b may project above upper surface 32a of annular table top 32 and have recesses to receive and hold the ends of the wires, as noted, at their proximal ends (when they are first laid on the table) and at their distal ends when their layup is completed. In either case, trays 40, 42 may have clips mounted, for example, to flanges 40b, 42b to hold the ends of the wires.

In addition, as noted, and again referring to FIGS. 3B and 3C, trays 40 and 42 may support connector holders 45 that support and locate connectors 45a relative to the wire pathways formed by guides 16. Therefore, connector holders 45 are located at known locations in trays 40 or 42 adjacent the terminal ends of selected wires so that robot 12b can retrieve a connector from the connector holder and couple it to the terminal end of the wire that is adjacent the connector holder 45.

As best seen in FIG. 3C, each connector holder 45 includes a body 45b with at least one recess 45c for receiving and holding a connector 45a therein and couplers 45d for engaging flanges 40b, 42b, and 40c, 42c, such as at recesses 40d, 42d formed in flanges 40b, 42b, 40c, 42c of trays 40, 42, which define known locations for the connector holders. The defined locations can be physically and/or electronically (e.g. stored in master control system 72 and/or in the robot-based control system) associated with the terminal ends of known wires of a wire harness being assembled.

In addition, the connector holders 45 may include a readable label 45e that identifies the connector and the harness to which the connector is to be coupled. For example, the readable label may be a scannable label, such as a bar code, that can be read by the robot 12b so the robot 12b can verify that the connector is for coupling to the ends of the wires of the harness being assembled and to which wire the connector is to be coupled by the robot 12b. As noted above, the wires may be labeled also with a bar code so the robot 12b can scan the wire label prior to laying the wire or after laying the wire. The term “bar code” as used herein is intended to be used broadly and include one dimensional and two dimensional barcodes, such as barcodes formed from a plurality of lines (or bars) or barcodes formed from a plurality of shapes, such a Qcodes, QRcodes, DotCodes, EZcodes, or the like, as well as color barcodes.

Returning again to FIG. 1A, the process of assembling of the wire harness starts with wire being feed from wire feeders (e.g. drums) to a wire cut-to-length apparatus 22. The wire feeders are staged and positioned outside of the robotic work cell of robot 12a. A wire is then fed into wire cut-to-length apparatus 22, which is programmed with the wire information for a particular wire harness and will laser mark the wire to the desired length for a particular harness. The wire cut-to-length apparatus 22 will feed the wire into wire winding apparatus 24, which is configured to wind the wire round a bobbin 44 and then when the full length has been dispensed, wire cut-to-length apparatus 22 will cut the wire to suitable length. As will be more fully described below, the bobbin 44 is configured such that when the wire is wound onto the bobbin 44 both ends of the wire will be extended and available so that the wire can be stripped, terminated, and checked for conductivity.

Optionally, the wire cut-to-length apparatus 22 may also label the wire, for example, using a readable label, including a scannable label, such as a bar code, so that it can be read by robots 12a, 12b. The selection of which harness is to be assembled may be done locally by a worker with input at the wire cut-to-length apparatus 22 via a user interface or remotely input by a master control system, which is in communication with the control system of the wire cut-to-length apparatus 22. For example, a suitable wire cut-to-length apparatus can manage wire gauges from 26 American wire gauge (AWG) to 4 American wire gauge (AWG), and optionally 20 AGW to 8 AWG, and it can manage up to sixteen (16) wires at one time.

As noted, the wire is fed to wire winding apparatus 24 from wire cut-to-length apparatus 22. Wire winding apparatus 24 winds the wire onto an empty bobbin 44a leaving the starting or proximal end of the wire projecting from the bobbin until the correct length of the wire is wound on the bobbin. After the proper length of wire is wound on the bobbin, the wire is cut (by wire cut-to-length apparatus 22) so that the other one end (e.g. distal end) of the wire is also extended from the full bobbin 44b for post winding treatment.

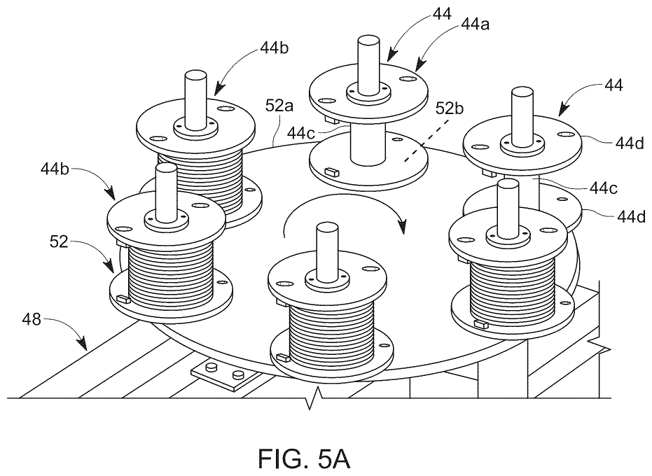

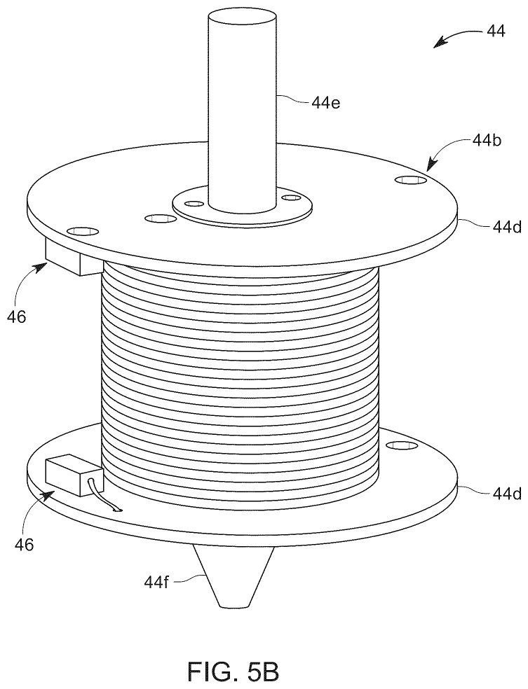

Referring to FIG. 5, the bobbins 44 may include wire holders or arresters 46 to hold both ends of the wire so that the front end and the tail end of the wire are available for after processing, as described below. Robot 12a then picks a full bobbin 44b from the winding station and places an empty bobbin 44a in the wire winding apparatus 24. As will be more fully described below, the bobbin design will allow the robots to pick, place, and dispense the wire as needed for the process described below.

After picking the full bobbin 44b, robot 12a then presents both wire ends (which are extended from the bobbin) to strip and terminate machines 26, which will strip and then terminate the ends as needed. As noted, suitable strip and terminate machines 26 are available from KOMAX. After the wire ends are stripped and terminated, robot 12a will then optionally present both ends of the wire to a wire testing apparatus 28 to verify continuity. This will check the integrity of the wire and terminals. If the check passes, the wire and bobbin 44b will continue on in the process, and robot 12a will place the full bobbin 44b in queue for use by robot 12b. If it does not pass, the wire and bobbin will be rejected and discarded, for example, in to bin 28a and a new wire will be processed.

Referring again to FIG. 1, wire harness assembly system 10 also includes a layup feed station or work surface 48, such as a table, adjacent wire harness layup table 14, where the full bobbins 44b are deposited by robot 12a and empty bobbins 44a are returned by robot 12b. Work surface 48 may have a designated picking location, where the full bobbins 44b are placed by robot 12a for picking by robot 12b and a designated return location, where the empty bobbins 44a are returned by robot 12b and then picked by robot 12a for reprocessing. After picking an empty bobbin, robot 12a will present it to wire winding apparatus 24 and then move it though its post winding treatment by split and termination machines 26, and optional testing by testing apparatus 28. Thus, while an empty bobbin is being wound with wire by wire winding apparatus 24, robot 12a can present another bobbin loaded with wire to robot 12b for the next cycle.

In one embodiment, as noted, wire harness assembly system 10 may also include an accumulator 50 to hold and accumulate full bobbins 44b that are ready for use by robot 12b. Accumulator 50 may be located in the layup feed station and may also hold and accumulate one or more empty bobbins 44e for robot 12a.

As best seen in FIG. 5A, accumulator 50 includes a rotatable support 52, which is mounted to, for example, work surface 48 for rotation. For example, rotatable support 52 may comprise a plate 52a, such as a circular plate, with plurality of holders 52b (e.g., recesses or projecting pins) for holding filled bobbins 44b and on which the bobbins are placed by robot 12a or 12b. The holders may be filled with ready-to-use full bobbins 44b, and one or more empty bobbins 44. When rotated, accumulator 52 can present a full bobbin to robot 12b and can return an empty bobbin to robot 12a for reprocessing.

To rotatably mount plate 52a to work surface 48, rotatable support 52 may include a downwardly depending spindle that extends through work surface 48 and is rotated by a driver, such as a motor, including an indexing motor, that is mounted under work surface 48 to rotate support 52 between indexed positions so that a full bobbin 44b is in the picking location for robot 12b to grab and pick the full bobbin 44b for laying the wire on the wire harness layup table 14 and so that an empty bobbin is in a return location for picking by robot 12a. The driver for rotatable support 52 may also be controlled by the main control system 72, described above, so that the correct full bobbin is positioned in the picking location and an empty bobbin can be in position for reprocessing. Therefore, once a full bobbin 44b is placed in the layup feed station and is ready for robot 12b to pick up, robot 12a will be able to pick an empty bobbin from the layup feed station for reprocessing.

As best seen in FIG. 5B, each bobbin 44 includes a central spool 44b (about which the wire is wound by wire winding machine 24) with upper and lower flanges 44d. Upper and lower flanges 44d support wire holders or arresters 46, so that as noted above, so that the front end and the tail end of the wire are secured in place on the bobbin but available for processing by split and termination machine 26, and optional wire testing apparatus 28.

As best seem on FIGS. 5A and 5B, each bobbin 44 also includes a projecting coupler 44e, such as a pin or shaft, that extends upwardly from upper flange 44d for engagement by robots 12a, 12b. Each bobbin 44 also may include a coupler 44f for releasably coupling the bobbin 44 to accumulator 52. In the illustrated embodiment, the coupler 44f comprises a downwardly projecting conical spindle that couples the bobbin 44 to accumulator 52 and, further, provides a guide surface (outer surface of spindle) to help the robot guide the bobbin in to a corresponding holder 52, such as a recess, provided on plate 52a. However, it should understood that this coupler arrangement may be reverse—that is the projecting coupler may be mounted on the rotatable support and the recess may be provided in the underside of the bobbin.

Referring to FIGS. 4A-4J, as noted above, the process may start with robot 12a picking an empty bobbin (e.g. from work surface) and placing it in the wire winding apparatus 24 where the wire is wound onto the bobbin and then cut to the specified length for the harness being assembled. Once the bobbin is full with the wire, robot 12a will present it to the split and termination machine 26 where the ends of the wires are prepared. The robot 12a will then present the full bobbin to the wire testing machine 28, as noted above. Once a full bobbin is tested and has passed the testing, robot 12a will place the full bobbin on work surface 48 (or on the accumulator 52). After that, robot 12b will pick the full bobbin and then place the first end of the wire of the full bobbin on the wire harness layup table 14 at the start of the wire path for the particular harness being assembled and then unreel the bobbin as it moves the bobbin along the selected path for that wire based on the harness being assembled.

The information about the wire and the harness being assembled may be input in to the robot-based control system and/or master control system, described above. Thus, based on the harness being assembled, robot 12b will lay the wire of the bobbin (presented by robot 12a) on the selected annual and radial wire paths on wire harness layup table 14 for that particular harness being assembled. After the wire has been fully laid on the table, the robot 12b will return the empty bobbin to the work surface, for example to the return location on the work surface, where robot 12a will retrieve the empty bobbin for reprocessing. This process is repeated until all the wires for the harness have been laid on the table. It should be understood that while an empty bobbin is being processed by wire winding apparatus 24, robot 12a may process another full bobbin and present it to the split and termination machine 26 and then once tested and approved place that full bobbin on work surface 48 for processing by robot 12b.

After all the wires have been laid on wire harness layup table 14 for a given harness, robot 12b then couples the ends of the wires that are tagged to receive a connector with the appropriate connector. As noted above, the robot 12b may read the readable labels on the connector holders 45 to confirm that the correct connector 45a is located adjacent the end of the wire for coupling to the wire end that is adjacent the connector holder. Once robot 12b confirms that the correct connector holder is present, robot 12b will pick the connector 45a and place it in the end of the wire and couple the two together.

Once all the connectors have been mounted to the respective wires (that require connectors), master control system 72 will move the wire harness layup table 14 to work station S2, where cabling, such as purchased cables, including HDI cable, digital cables or the like, can be manually laid on the table. Further, work station S2 can be where any splicing is performed. Once the cabling is laid, then the wires and cabling can then be tied together, for example, by plastic ties.

After the cabling is added and the harness is tied together, master control system 72 will then move the wire harness layup table 14 to work station S3, where the harness may be taped and loomed. Once taped and loomed, master control system 72 will move the wire harness layup table 14 to work station S4 where the harness is removed from wire harness layup table 14 and the table can then be set up for the next harness. When retractable pins are employed, master control system 72 will lower the retractable pins to ease removable of the wire harness.

The wire harness layup tables 14 may be moved in unison once all the step are completed at each work station or they may be moved independently, though this may require system 10 to have a larger footprint or have holding locations for the tables between the work stations.

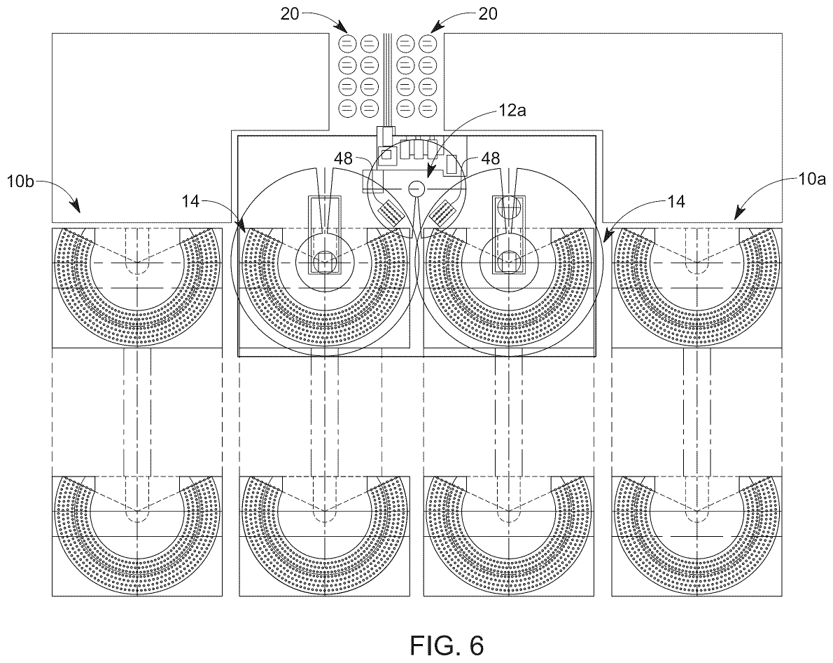

As would be understood, although wire harness assembly system 10 is shown in FIGS. 1-3 with a single loop or circuit 10a, wire harness assembly system 10 may be configured with multiple loops or circuits, and optionally share robot 12a when the loops are adjacent. Referring to FIG. 6, wire harness assembly system 10 may include two side by side loops 10a and 10b and locate the wire processing area in close proximity so that they can share robot 12a that presents full bobbins to two work surfaces 48 adjacent a respective wire harness layup table 14 of each loop 10a, 10b.

Further, referring to FIG. 7, the loop of the wire harness assembly system may be compact and be formed by a rotating wire harness layup table. As best seen in FIG. 7, wire harness assembly system 110 may be formed by a single wire harness layup 114 rotates about robot 12b and indexes between two positions, with robot 12a also located outside the path of the table 114 similar to robot 12a. So rather than having four locations for its work stations S1-S4, wire harness assembly system 110 has one table 114 that is in one location but is indexed to two orientations with four work stations S1, S2, S3, and S4, three of which (S2, S3 and S4) being closely located on one half of the circular wire harness layup 114. For more details of table 114 reference is made to tables 14 described above.

Accordingly, the wire harness assembly process described herein can reduce the labor-intensive process and mitigate quality issues. The use of an annular working space for laying out the wire and in combination with the use of industrial robot in the layout process, especially is simplified for larger harnesses, and the use of the robots can decrease the assembly process time. Further, because some of the more cumbersome manual harness assembly steps are separated from those which can be automated, the through-put of the system is greatly increased.

The above description is that of current embodiments. Various alterations and changes can be made without departing from the spirit and broader aspects as defined in the appended claims, which are to be interpreted in accordance with the principles of patent law including the doctrine of equivalents. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described herein may be combined with other elements or replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present disclosure is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

We claim:

1. A wire harness assembly system for assembling a wire harness having a plurality of harness wires, said wire harness system comprising:
a table top supported above a floor along a Y axis, said table top having a support surface having a perimeter and extending in an X axis and a Z axis;
a plurality of guides mounted relative to said table top in known locations across said support surface wherein each of said guides has a unique known location along said X and Z axes, said plurality of guides defining a plurality of wire paths for harness wires to form a variety of harnesses; and
a robot supported adjacent said table top, said robot having a robotic arm configured to engage a harness wire and to lay the harness wire in a selected wire path of said plurality of wire paths.

2. The wire harness assembly system according to claim 1, wherein said plurality of guides are located in an annular arrangement on said table top.

3. The wire harness assembly system according to claim 1, wherein said guides are located in an annular arrangement along concentric axes and radial axes on said table top.

4. The wire harness assembly system according to claim 1, wherein said table top comprises an annular table top having a center axis, and said robot located at said center axis.

5. The wire harness assembly system according to claim 1, further comprising a control system, said control system having access to information about a wire harness that is to be assembled on said table top and configured to select a wire path from said plurality of wire paths based on said information about the wire harness and to have said robot lay a wire in the selected wire path.

6. The wire harness assembly system according to claim 5, wherein said robot has a robot-based control system wherein said control system is (1) said robot-based control system at said robot or (2) a master control system in communication with said robot-based control system.

7. The wire harness assembly system according to claim 6, wherein said information about the wire harness is resident in said robot-based control system.

8. The wire harness assembly system according to claim 1, further comprising at least one tray located adjacent said support surface of said table top, said guides having a footprint, and said tray configured to support thereon a plurality of connectors located at spaced locations around a portion of said perimeter of said support surface outside said footprint of said guides.

9. The wire harness assembly system according to claim 1, said robot having a work cell, further comprising an accumulator for holding a plurality of bobbins in said work cell.

10. The wire harness assembly system according to claim 9, wherein at least one of said bobbins has a harness wire wound thereon, and said robot having a robotic arm configured to engage said at least one bobbin from said accumulator and to lay the wire of said bobbin along a selected wire path of said plurality of wire paths.

11. The wire harness assembly system according to claim 10, wherein said accumulator includes a rotatable support, and said support includes a plurality of bobbin holders for holding said plurality of bobbins.

12. The wire harness assembly system according to claim 10, wherein said robot comprises a first robot, further comprising a second robot, and said second robot being configured to place at least some of said plurality of bobbins on said accumulator.

13. The wire harness assembly system according to claim 12, wherein said first robot is configured to place an empty bobbin on said accumulator after laying the wire of said empty bobbin on said table top.

14. The wire harness assembly system according to claim 1, wherein said guides are retractable wherein said table top is free of any projections when said guides are retracted.

15. A wire harness layup table comprising:
a table top supported relative to a floor along a Y axis, said table top having a support surface having a perimeter and extending in an X axis and a Z axis; and
a plurality of guides mounted relative to said table top in known locations across said support surface wherein each guide has a unique known location along said X and Z axes, said plurality of guides located in an annular arrangement on said table top along concentric axes and radial axes defining a plurality of wire paths for harness wires to form a variety of harnesses.

16. The wire harness layup table according to claim 15, wherein said table top comprises an annular table top.

17. The wire harness layup table according to claim 15, wherein said guides comprise guide pins.

18. The wire harness layup table according to claim 17, wherein said guides pins comprise retractable guide pins.

19. A wire harness bobbin comprising:
a central hub;
upper and lower flanges mounted about said central hub for holding a wire on said wire harness bobbin when the wire is wrapped around said central hub; and
a coupler formed or mounted relative to said upper flange for engagement by a robotic arm.

20. The wire harness bobbin according to claim 19, further comprising a second coupler for coupling said wire harness bobbin to a support.

21. The wire harness bobbin according to claim 19, further comprising a wire holder for holding the end of a wire wrapped around said central hub.

22. The wire harness bobbin according to claim 21, further comprising a second wire holder, wherein said upper and lower flanges each have an inwardly facing side, and said wire holders are mounted to said inwardly facing sides of said upper and lower flanges, respectively.
